(19) United States
(12) Patent Application Publication
(10) Pub. No.: US 2017/0372303 A1
(43) Pub. Date: Dec. 28, 2017

(54) ELECTRONIC PAYMENT FOR CASH EXCHANGE SYSTEM

(71) Applicant: VISA INTERNATIONAL SERVICE ASSOCIATION, San Francisco, CA (US)

(72) Inventor: Rahul Kochhar, Ashburn, VA (US)

(21) Appl. No.: 15/190,385

(22) Filed: Jun. 23, 2016

(51) Int. Cl. G06Q 20/38; G06Q 20/32; G06Q 20/10

(52) U.S. Cl. CPC G06Q 20/381; G06Q 20/10; G06Q 20/3224

(57) ABSTRACT

A computer-implemented method of exchanging cash for electronic payment is disclosed. The method includes the steps of registering a first payment account with a money exchange server using a first user computing device, establishing communication between the first user computing device and the money exchange server, and transmitting a request for cash. The method also includes the steps of establishing communication between the money exchange server and a second user computing device providing access to a second payment account, where the second payment account is associated with a second user, transmitting the request for cash to the second user computing device, and accepting the request via the second user computing device. The method further includes the steps of transmitting an acceptance message from the second user computing device to the money exchange server and location information of the first user computing device to the second user computing device.

### CROSS-REFERENCE TO RELATED APPLICATIONS

None.

### BACKGROUND

Today most payments are made electronically using credit and debit cards or via mobile payment applications. Thus, most people are not in the habit of carrying cash. However, there are times when cash is required either because a particular merchant or seller only accepts cash or a particular situation demands it. This may be because an automated teller machine (“ATM”) transaction is not possible or the amount needed exceeds the daily ATM withdrawal amount allowed. Under currently available methods and applications, if an automated teller machine (“ATM”) transaction is not possible, a consumer in need of cash would have no means to obtain it. Thus, there is a need for a system that allows for the exchange of cash for electronic payment.

### SUMMARY

In one aspect, a computer-implemented method of exchanging a cash amount for electronic payment is disclosed. The method includes the steps of registering a first payment account with a money exchange server using a first user computing device, where the first payment account is associated with a first user, establishing communication between the first user computing device and the money exchange server, and transmitting a request for cash amount from the first user computing device to the money exchange server, where the request for cash amount includes location information of the first user computing device. The method also includes the steps of establishing communication between the money exchange server and a second user computing device, the second user computing device providing access to a second payment account that is registered with the money exchange server, where the second payment account is associated with a second user. The method includes the steps of transmitting the request for cash amount from the money exchange server to the second user computing device and accepting the request for cash amount via the second user computing device. The method further includes the steps of transmitting an acceptance message from the second user computing device to the money exchange server and transmitting from the money exchange server the location information of the first user computing device to the second user computing device.

In another aspect, a computer-implemented method of exchanging a cash amount for electronic payment is disclosed. The method includes the steps of registering a first payment account with a money exchange server using a first computing device, where the first payment account is associated with a first user, establishing communication between the first user computing device and the money exchange server, and transmitting a request for cash amount from the first user computing device to the money exchange server, where the request for cash amount includes location information of the first user computing device. The method also includes the steps of storing the location information of the first user computing device on the money exchange server, establishing communication between the money exchange server and a second user computing device, the second user computing device providing access to a second payment account that is registered with the money exchange server and associated with a second user. The method includes the steps of establishing communication between the money exchange server and a third user computing device, the third user computing device providing access to a third payment account that is registered with the money exchange server and associated with a third user. The method also includes the steps of transmitting the request for cash amount from the money exchange server to the second user computing device and the third user computing device and accepting the request for cash amount via the second user computing device. The method includes the steps of transmitting an acceptance message from the second user computing device to the money exchange server and transmitting from the money exchange server the location information of the first user computing device to the second user computing device.

In a further aspect, a system for exchanging a cash amount for electronic payment using a payment app is disclosed. The system includes a money exchange server, a first user computing device configured to communicate with the money exchange server, which transmits a request for cash amount to the money exchange server via the payment app. The system also includes a second user computing device configured to communicate with the money exchange server, which receives the request for cash amount from and sends an acceptance of the request for cash amount to the money exchange server via the payment app. The system further includes a first electronic payment account associated with the first user computing device and a second electronic payment account associated with the second user computing device. The money exchange server facilitates the transfer of electronic funds from the first payment account to the second payment account in an amount that is more than or equal to the cash amount requested.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIGS. 1 and 1A illustrate an embodiment of a system for exchanging cash for electronic payment in accordance with the disclosure;

FIG. 2 illustrates the exchanging of cash for electronic payment in the system of FIGS. 1 and 1A;

FIG. 3 illustrates a method for exchanging cash for electronic payment in accordance with the disclosure;

FIGS. 4A and 4B illustrate another method for exchanging cash for electronic payment in accordance with the disclosure;

FIG. 5 is an illustration of a communication system for communication between a user computing device and a money exchange server;

FIG. 6 is an illustration of a user computing device; and,

FIG. 7 is an illustration of a money exchange server.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### Specification

The present disclosure now will be described more fully with reference to the accompanying drawings, which form a part hereof, and which show, by way of illustration, specific exemplary embodiments by which the invention may be practiced. These illustrations and exemplary embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the example embodiments may take the form of an entirely hardware embodiment, an entirely software embodiment, or an embodiment combining software and hardware aspects. The following detailed description is, therefore, not to be taken in a limiting sense.

The example embodiments describe a system, method, apparatus, and computer readable media that may be configured to enable a first user using a first user computing device to request and receive cash from a second or other user using a second or other user computing device in exchange for electronic payment from an account associated with the first user to an account associated with the second user.

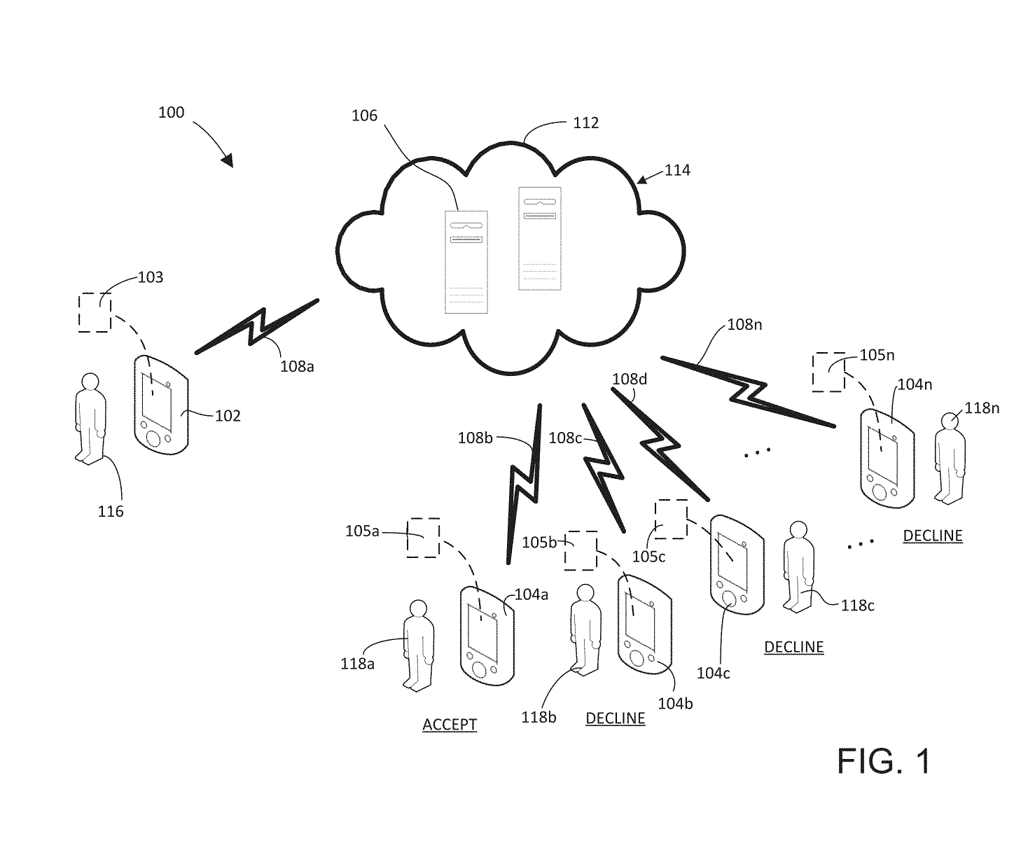

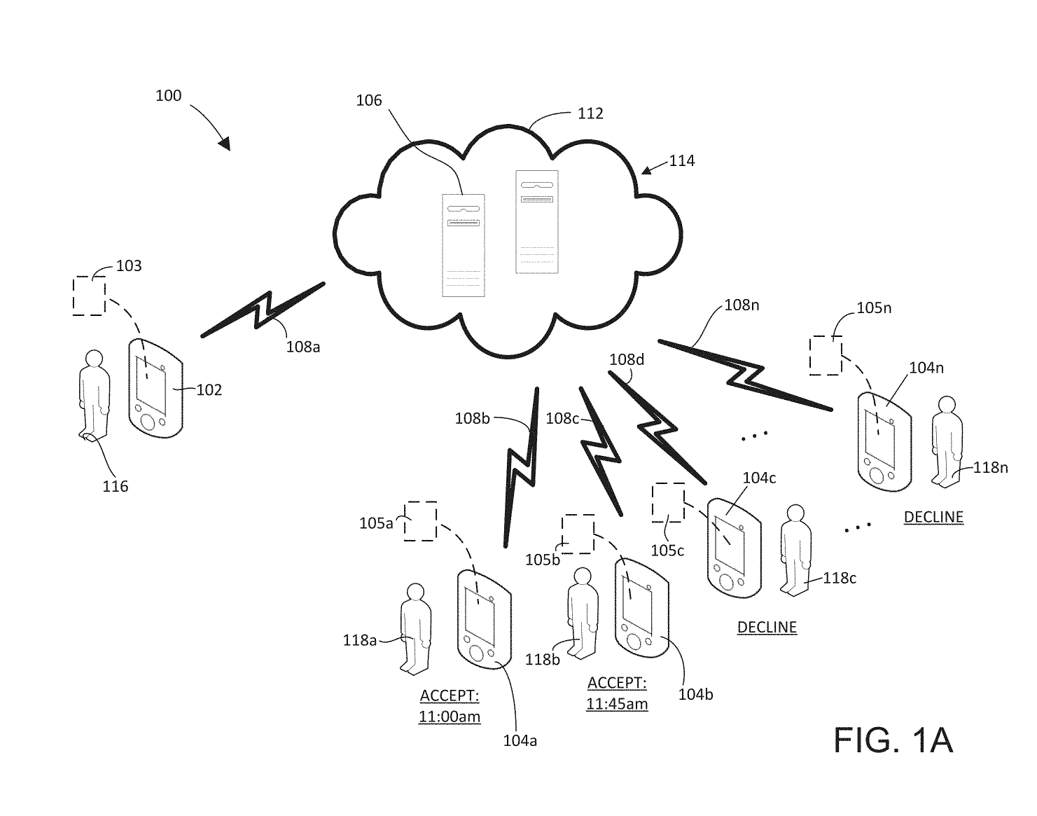

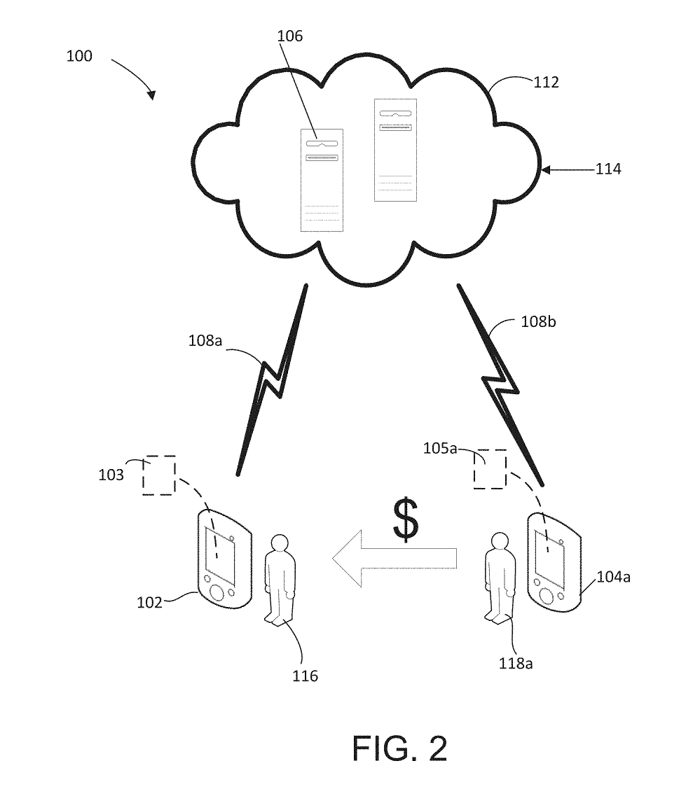

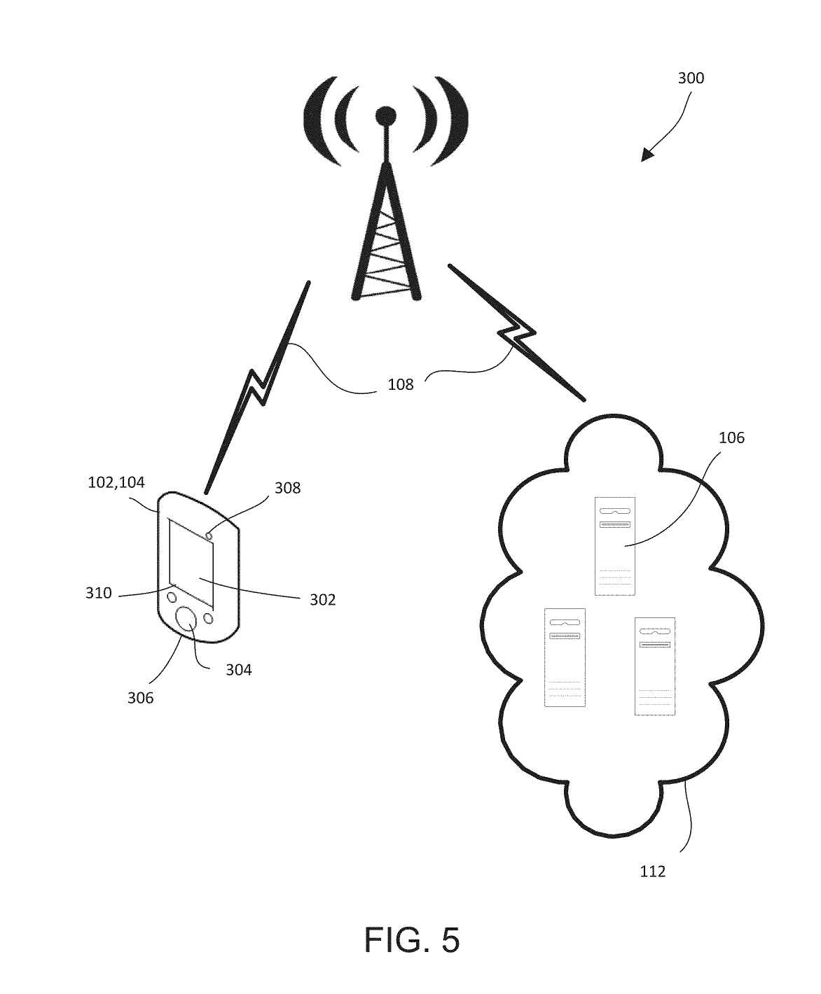

FIGS. 1, 1A, and 2 illustrate a system 100 in accordance with example embodiments. The system 100 may include a first user computing device 102 and one or more other user computing devices 104a, b, . . . , n (referred to collectively herein as “user computing devices” or “user devices”) that may communicate with a money exchange server 106 via one or more communication channels 108. The user computing devices 102, 104 may be a smart phone, a lap top, or other device capable of communicating data as further discussed with respect to FIG. 5.

The user computing devices 102, 104 may store a software payment application (“payment app”) 110 that was downloaded at some previous point in time or otherwise installed onto the user computing devices 102, 104. The payment app 110 may be used to access a first payment account 103 associated with user computing device 102 and/or a first user 116, or other payment accounts 105a, b, . . . , n associated with other user computing devices 104a, b, . . . , n and/or other users 118a, b, . . . , n. The first payment account 103 and the other payment accounts 105a, b, . . . , n may be associated with a credit card, debit card, or other type of payment account. The payment app 110 may enable communication between the user computing devices 102, 104 and the money exchange server 106 and between the first user computing device 102 and the other user computing devices 104.

The money exchange server 106 may be a single server or a cloud of servers 112 that are coupled to or form part of a payment processing network 114, which communicates with an issuing bank and an acquiring bank to approve or decline a requested payment transaction. Example payment transactions may include requesting payment using a debit account, a credit account, or other account. Details of the payment processing network may be well-known and not further described herein.

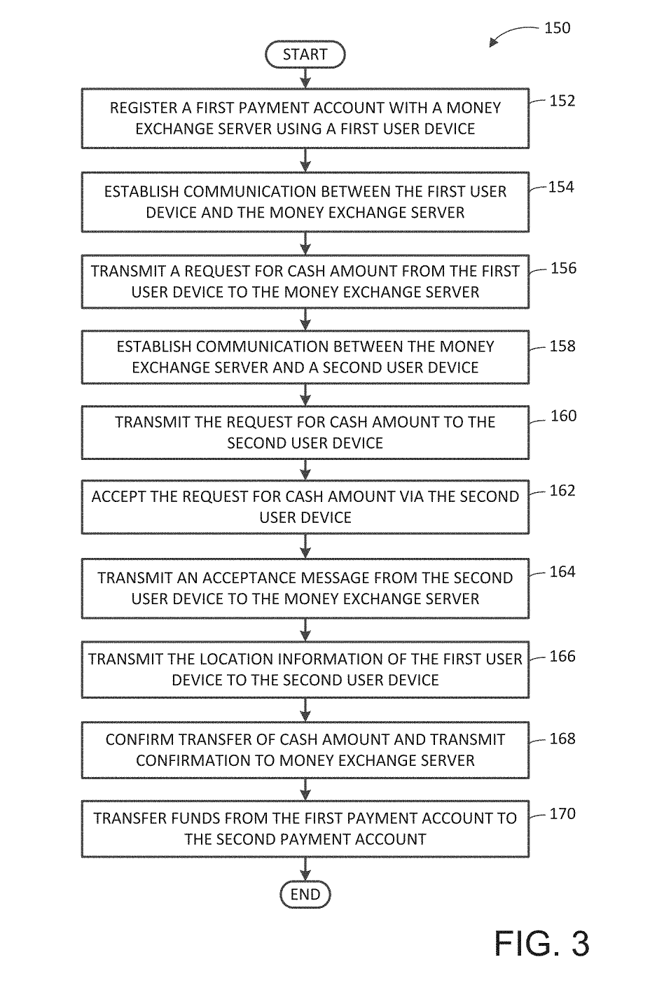

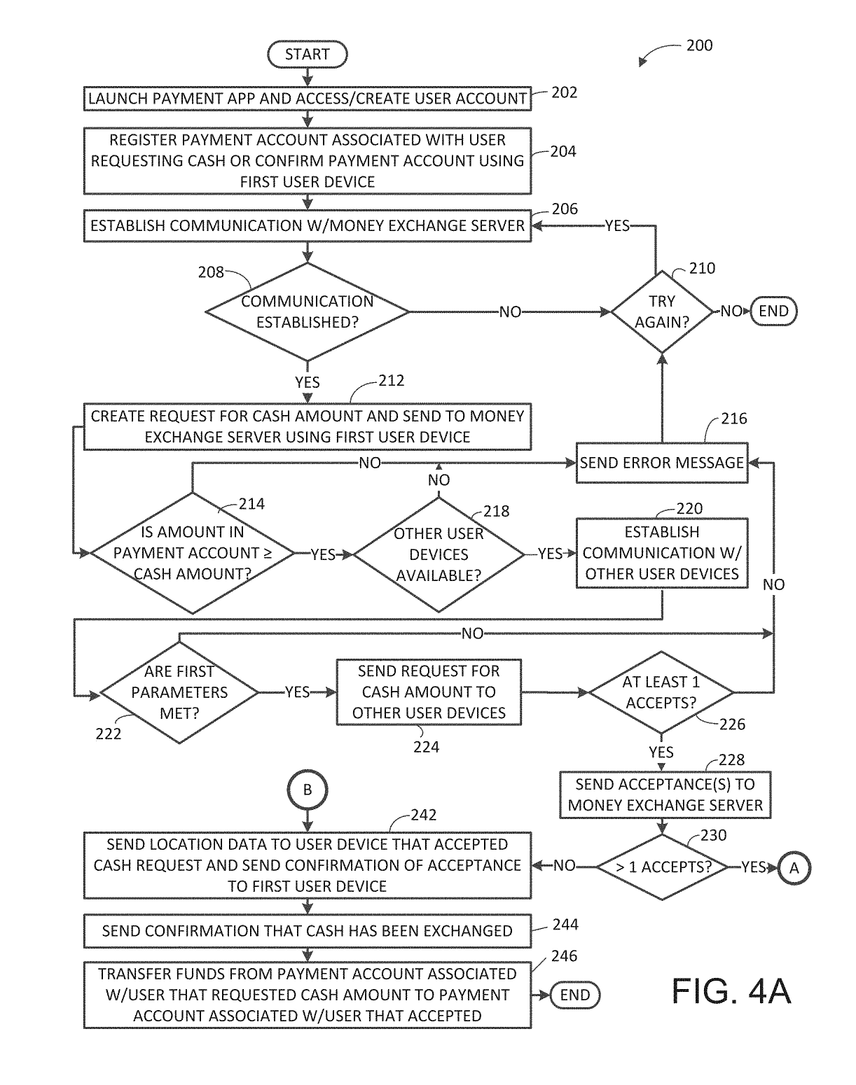

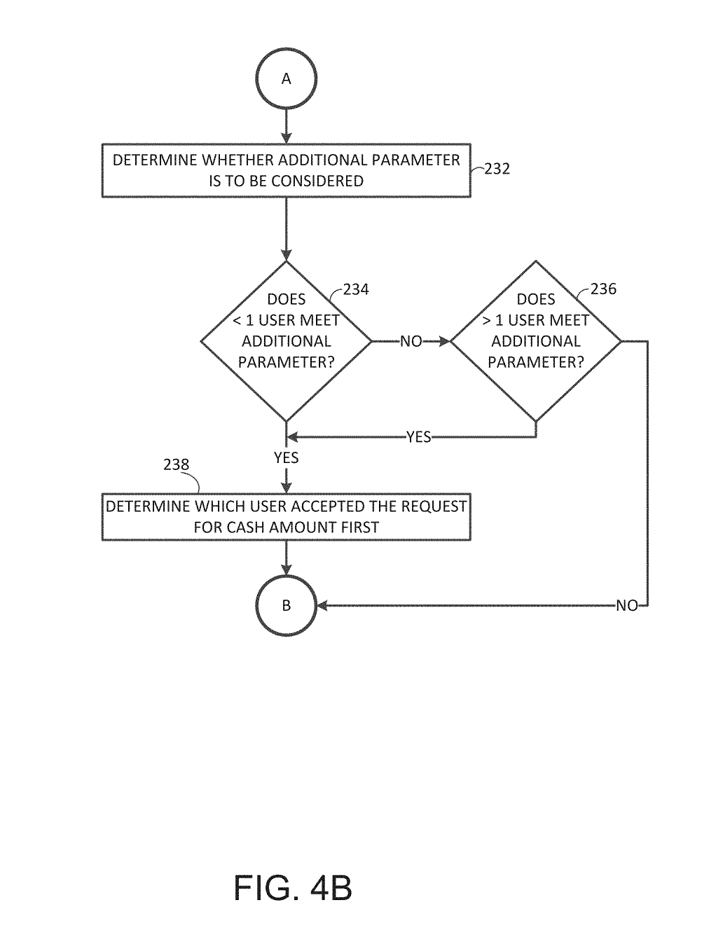

FIG. 3 may illustrate a flow diagram of a method 150 and FIGS. 4A and 4B may illustrate a flow diagram of a method 200 for requesting cash in exchange for electronic payment in accordance with example embodiments. The flow diagrams may be implemented by a system or apparatus, such as, for example, user computing devices 102, 104 and money exchange server 106. Each of the blocks shown in the flow diagrams may be repeated one or more times, one or more of the blocks may be modified, and one or more of the blocks may be omitted. The methods may be stored on a non-transitory computer readable medium as computer executable instructions. The computer executable instructions, when executed by at least one processor, may cause at least one computer or other device to perform the blocks as steps of a method one or more times.

The flow diagram of FIG. 3 illustrating the method 150 may begin at a block 152. At a block 152, the first user 116 may register the first payment account 103 with the money exchange server 106 using the payment app 110 on the first user computing device 102. At a block 154, communication may be established between the first user computing device 102 and the money exchange server 106. At a block 156, the first user may use the payment app 110 to transmit a request for a cash amount from the first user computing device 102 to the money exchange server 106. The money exchange server 106, at a block 158, may establish communication with one or more other user computing devices 104a, b, . . . n. At a block 160, the money exchange server 106 may transmit the request for cash amount to one or more of the other user devices 104. One of the other users 118a, b, . . . n may accept the request for cash amount at a block 162 using the other user computing devices 104.

At a block 164, an acceptance message may be transmitted from the other user computing device 104 to the money exchange server 106. Upon receipt of the acceptance message, at a block 166, the money exchange server 106 may transmit the location information of the first user computing device 102 to the other user computing device 104. At a block 168, the other user 118 may locate and give the first user 116 the cash amount requested and the first user 116 may use the first user computing device 102 to confirm the transfer of the cash amount and a confirmatory message may be transmitted from the first user computing device 102 to the money exchange server 106. Likewise, the other user 118 may use the other user computing device 104 to confirm the transfer of cash amount, and a confirmatory message may be transmitted from the other user device 104 to the money exchange server 106. Upon receipt of the one or more of the confirmatory messages, at a block 170, the money exchange server 106 may transfer funds from the first payment account 103 to the second payment account 105.

Turning to FIGS. 4A and 4B, the flow diagram illustrating the method 200 may begin at a block 202. In block 202, the payment app 110 may be launched. The first user 116 may log-in to his user account or create a new user account by entering account information such as a username and password as well as other identifying information. The user account may store the account information in the payment app 110 so that the user 116 does not need to enter his account information each time the payment app 110 is launched.

In block 204, the first user 116 may register a debit, credit, or other type of payment account 103 with the payment app 110. The payment app 110 may be associated with the money exchange server 106 and the payment account 103 may be stored on the money exchange server 106 in a memory 365 or 370 (see FIG. 7). If multiple first payment accounts 103 have been entered, the payment app 110 may request that the user 116 confirm which payment account 103 should be used for the transaction. Similarly, other users 118a, b, . . . , n may also access or create user accounts using the payment app 110 and register a debit, credit or other type of payment account 105a, b, . . . , n with the payment app 110 using other user computing devices 104a, b, . . . n.

In a block 206, the first user computing device 102 may establish communication with the money exchange server 106, which may occur upon the launching of the payment app 110 or it may be established at a later time. Communication may be established by the user computing device 102 communicating a ready to transact message to the money exchange server 106 via a first communication channel 108a. The ready to transact message 204 may include the first user account information, such as the username and password or other identifying information, such as geographical location. The money exchange server 106 may confirm the account information of the first user 116 and send a verification message that the first user 116 can make a transaction. The verification message may be visibly shown on display 302 of the first user computing device 102, or through a tactical indication of verification.

If communication is not established, in a block 208, the payment app 110 may display a message on the display 302 of the first user computing device 102 that communication could not be established. If communication has been established then the method proceeds to a block 212.

In a block 210, the payment app 110 may display a message on the display 302 asking the first user 116 of he would like to try again. Or, the payment app 110 may automatically try to establish communication with the money exchange server 106 again or may exit the payment app 110.

In block 212, the user may use the payment app 110 on the first user computing device 102 to create and send a request for cash amount (e.g., $20, $50, $100, etc.) to the money exchange server 106. Location information of the first user computing device 102 may also be sent to the money exchange server 106 as part of the request for cash amount or as a separate communication. The location information may include geographical coordinates, a map, or directions. The money exchange server 106 may store the location information in the memory 365 or 370 (see FIG. 7).

In a block 214, the money exchange server 106 may determine if the funds available in the first user's 116 payment account 103 or the credit limit associated with the first payment account 103 are greater than or equal to the cash amount requested. If the cash amount requested exceeds the funds available or credit limit, then the money exchange server 106 may send an error message at a block 216 to the first user computing device 102. A surcharge may also be applied to any electronic transfer of funds from the first payment account 103 to any of the other payment accounts 105. If a surcharge is to be applied, then the money exchange server 106 may determine if the funds or credit line available in the first user's payment account 103 are greater than or equal to the cash amount requested plus the amount of the surcharge. If the cash amount requested plus the surcharge amount exceeds the funds available or the credit limit, then the money exchange server 106 may send an error message at block 216 to the first user computing device 102.

In a block 218, the money exchange server 106 may send out an alert message to the other user computing devices 104a, b, . . . , n via the communication channels 108b, c, . . . , n to see if they are available for a transaction. If no other user computing devices 104 are available then the money exchange server 106 may send an error message at block 216 to the first user computing device 102.

If one or more other devices 104 are available for a transaction, communication may be established in a block 220 between the money exchange server 106 and the one or more other user computing devices 104 available via communication channels 108b, c, . . . , n. The other user computing devices 104 may send a ready to receive message to the money exchange server 106 once communication is established. The ready to receive message may include the user account information associated with the other users 118, such as a username and password or other identifying information, such as geographical location. The money exchange server 106 receives the ready to receive message and may confirm the account information of the other users 118 and send a verification message that the other users 118 can make a transaction. The verification message may be visibly shown on a display 302 of the user computing devices 104, or through a tactical indication of verification.

In a block 222, the money exchange server 106 may determine if a first parameter is met. The first parameter may be in relation to the distance of the other user computing devices 104 to the first user computing device 102. For example, the money exchange server 106, may determine which user computing devices are within a 1, 5, or 10 mile radius of the first user 102 or at a location such that the other user 118 would be able to reach the first user 116 within a certain time frame (e.g., 5, 10, 15 minutes). The first parameter may be a specific location such as a particular city or neighborhood. The first parameter may be a set time by which the other users 118 can accept the offer before it expires. The first parameter may also be a personal attribute, such as age or gender or a peer rating associated with the other user 118. The first parameter may be pre-programmed within the payment app 110. The first parameter may be selected by the first user 116 during account registration or may be inputted by the first user 116 at the time the request for cash is created and sent with the request for cash amount. It is also contemplated that no first parameter may be evaluated at block 222.

If no first parameter is evaluated at block 222, then the request for cash amount may be sent to all other user computing devices 104 that are in communication with the money exchange server 106. As shown in FIGS. 1 and 1A, all the other users 118a, b, . . . , n or other user computing devices 104a, b, . . . , n meet the parameter (or no parameter was evaluated), meaning all users may have been sent the request for cash amount

In a block 224, if one or more other users 118 or other user computing devices 104 meet the first parameter, the money exchange server 106 may transmit the request for cash amount to those user computing devices 104. If there are no other users 118 or user computing devices 104 that meet the parameter, in block 216, the money exchange server 106 may communicate an error message to the first user computing device 102 informing the first user 116 that no other users 118 were found. The first user 116 may exit the payment app 110, try again, or may choose to change one of the parameters and resubmit the message.

In a block 226, the other users 118 may either accept or decline the request for cash. A non-response to the request may be treated as a decline. If there are no acceptances, an error message may be communicated to the first device 102, at which point the first user 116 can try communicating another request for cash amount. If at least one other user 118 accepts the request, then an acceptance message may be communicated to the money exchange server 106 at a block 228.

The request for cash may be accepted through an input by the other users 118. For example, the other user 118a may touch the display 302 of user computing device 104a or may input a command through an input pad 304. The request for cash may also be automatically accepted by the other user computing devices 104. The automatic acceptance may be based on a pre-selected amount, distance, or other criteria selected by the other users 118 so that whenever a request for cash is received that meets the criteria it may automatically be accepted.

In a block 230, the money exchange server 106 determines if more than one acceptance may have been received. If only one acceptance is received as shown in FIG. 1, the method may proceed to block 242. If more than one acceptance is received as shown in FIG. 1A, the method may proceed to a block 232.

In block 232, one or more additional parameter may be considered. The additional parameters may be pre-programmed or inputted by the first user 116. The one or more additional parameters may be related to location, distance, time, personal information related to the other users 118, or other considerations.

In a block 234, the money exchange server 106 may determine whether less than 1 other users 118 or user computing devices 104, which accepted the request for cash amount, satisfy the additional parameter. If less than one other users 118 or user computing devices 104 satisfy the parameter, the money exchange server 106 may determine which user 118 accepted the request for cash first and that user gets selected to fulfill the request for cash. For example, as illustrated in FIG. 1A, if two other users 118a and 118b accept the request for cash, the money exchange server 106 may then determine if an additional parameter is to be considered. If neither 118a and 118b or respective user computing devices 104a and 104b meet the additional parameter, the user that gets selected to fulfill the request for cash amount may be the one who accepted the request first. In the example shown in FIG. 1A, other user 118a, who communicated the acceptance first at 11:00 am, would be the user selected to fulfill the request for cash amount. Similarly, if no additional parameter is to be considered, then the other user that gets selected to fulfill the request for cash amount may be the other user that accepted first.

If one or more other users 118 or user computing devices 104 meet the additional parameter, then the method may proceed to a block 236. In block 236, the money exchange server 106 may determine if more than one other users 118 meet the additional parameter. If only one other user 118 or user computing devices 104 meets the additional parameter then that user or user computing device may be able to fulfil the request for cash amount and the method may proceed to block 242. If more than one other users 118 or user computing devices 104 meet the additional parameters, then the process may repeat until no other users 118 or user computing devices 104 meet further additional parameters or only one user or user computing device meets the further additional parameters.

In block 242, the money exchange server 106 may communicate the location information associated with the first user computing device 102 to the other user computing device 104 that is fulfilling the request for cash so that the other user 118 knows where to deliver the cash. It is contemplated that the other user 118 who is delivering the cash and/or the first user 116 may be able to contact each other through the payment app 110 or by other means to discuss a possible meeting point, particularly, if the first user 116 does not intend to stay in the same place. It is also contemplated that if the first user 116 moves to a new location, updated location information may be communicated to the money exchange server 106, which will relay the new location information to the other user that is delivering the cash. The other user may then deliver the cash amount requested to the first user 116. For example, as shown in FIG. 2, the other user 118a may deliver the cash to the first user 116.

In a block 244, the first user 116 and the other user 118 that delivered the cash, (e.g., 118a in FIG. 2) each may communicate a confirmation messages from the user computing devices 102 and 104a, respectively, to the money exchange server 106.

Once confirmation is received, in a block 246, the money exchange server 106 may electronically transfer funds from the first payment account 103 to the payment account 105a, b, . . . , n associated with the other user that delivered the cash amount (e.g., 105a in FIG. 2). The amount transferred may be equal to or more than the cash amount requested.

The method may end, may return to any of the preceding steps, and/or repeat one or more times.

FIG. 5 may be a high level illustration of some of the elements a sample computing environment 300 that may be physically configured to implement the various embodiments of the method and its logical variants. The user computing devices 102, 104 may store the software payment app 110 that may be accessed in a variety of ways. In addition, the payment app 110 may be obtained in a variety of ways such as from an app store, from a web site, from a store Wi-Fi system, etc. There may be various versions of the app to take advantage of the benefits of different computing devices, different languages and different API platforms.

The user computing devices 102, 104 may have display 302, which may or may not be a touch sensitive display. More specifically, the display 302 may have a capacitance sensor, for example, that may be used to provide input data to the user computing devices 102, 104. In other embodiments, input pad 304 such as arrows, scroll wheels, keyboards, etc., may be used to provide inputs to the user computing devices 102, 104. In addition, the user computing devices 102, 104 may have a microphone 306 which may accept and store verbal data, a camera 308 to accept images and a speaker 310 to communicate sounds.

The user computing devices 102, 104 may be able to communicate with the money exchange server 106 or a plurality of money exchange servers 106 that make up the cloud of computing devices 112. The user computing devices 102, 104 may be able to communicate via a communication network 312 such as cellular service, through the Internet, a private network, etc., having a variety of communication channels 108a, b, . . . , n. In some embodiments, the communication channels 108 may be wired such as through an Ethernet cable, a USB cable or RJ6 cable. In other embodiments, the communication channels 108 may be wireless such as through Wi-Fi (802.11 standard), Bluetooth, cellular communication or near field communication devices. The communication between the user computing devices 102, 104 and the money exchange server 106 may be direct or through a wireless network, e.g., Bluetooth, etc.

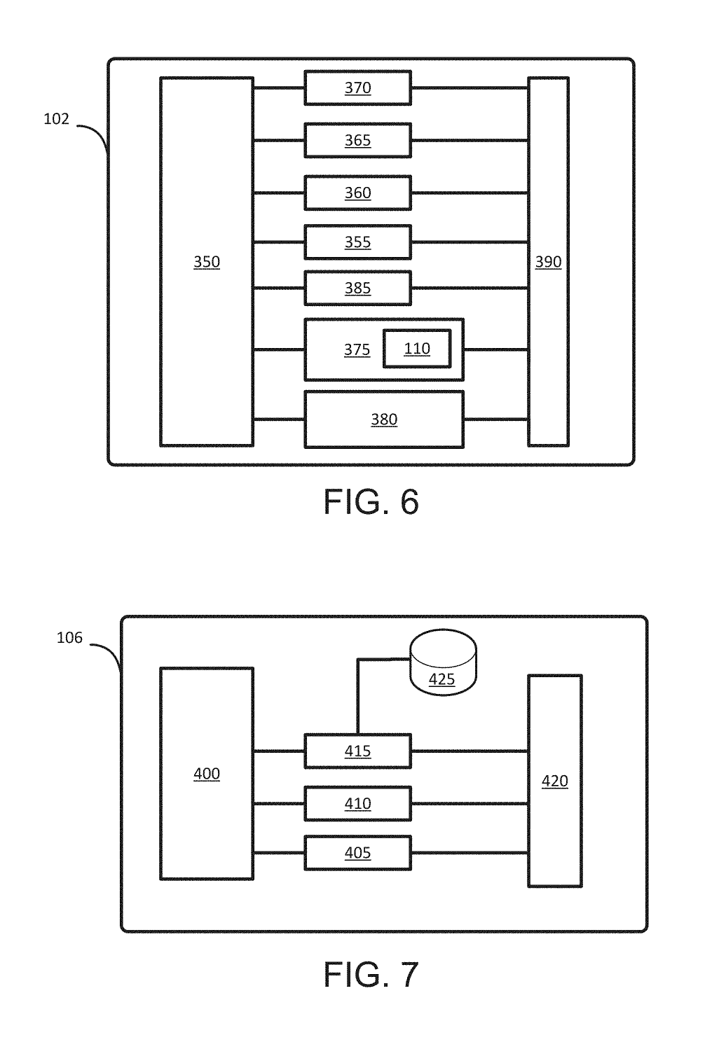

FIG. 6 may be a sample user computing device 102 or 104 that may be physically configured according to be part of the system. The user computing device 102, 104 may have a processor 350 that is physically configured according to computer executable instructions. It may have a portable power supply 355 such as a battery which may be rechargeable. It may also have a sound and video module 360 which assists in displaying video and sound and may turn off when not in use to conserve power and battery life. The user computing device 102, 104 may also have volatile memory 365 and non-volatile memory 370 as well as internal storage 375 or external storage 380 upon which the payment app 110 may be stored. The user computing device 102, 104 may have GPS capabilities 385 that may be a separate circuit or may be part of the processor 350. There also may be an input/output bus 390 that shuttles data to and from the various user input devices such as the microphone 306, the camera 308 and other inputs 302, etc. It also may control communicating with the networks, either through wireless or wired devices. Of course, this is just one embodiment of the user computing device 102, 104 and the number and types of user computing devices 102, 104 is limited only by the imagination.

FIG. 7 may illustrate an example of the physical elements that make up the money exchange server 106. Some of the physical elements may be located in other devices, depending on processing needs. The money exchange server 106 may have a processor 400 that is physically configured according to computer executable instructions. It may also have a sound and video module 405 which assists in displaying video and sound and may turn off when not in use to conserve power and battery life. The money exchange server 106 may also have volatile memory 410 and non-volatile memory 415.

In some examples, the money exchange server 106 may include a digital storage such as a magnetic disk, an optical disk, flash storage, non-volatile storage, etc. Structured data may be stored in the digital storage such as in a database. A database 425 may be stored in the memory 410 or 415 or may be separate. The database 425 may also be part of a cloud and may be stored in a distributed manner. There also may be an input/output bus 420 that shuttles data to and from the various user input devices such as microphones, the cameras, and inputs, etc. The input/output bus 420 also may control of communicating with the networks, either through wireless or wired devices. Of course, this is just one embodiment of the money exchange server 106 and the number and types of user computing devices 102, 104 and money exchange servers 106 is limited only by the imagination.

The system, devices and equipment may address a technical problem of how to effectively communicate the need for assistance in a manner that is likely to elicit a positive response in a prompt amount of time. By using specially designed servers to manage the communication flow to and from users and assistants, a single assistant may arrive in a prompt amount of time with the desired goods or services. Users no longer have to communicate a series of increasingly desperate series of messages but can rely on an application, hardware and communicate devices to have the desired good or service delivered in a prompt amount of time.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

The user computing devices, computers, and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user computing devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user computing devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described figures, including any servers, point of sale terminals, user computing devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow diagram, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for facilitating the exchange of cash for electronic payment. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A computer-implemented method of exchanging a cash amount for electronic payment, the method comprising the steps of:
registering a first payment account with a money exchange server using a first user computing device, wherein the first payment account is associated with a first user;
establishing communication between the first user computing device and the money exchange server;
transmitting a request for cash amount from the first user computing device to the money exchange server, wherein the request for cash amount includes location information of the first user computing device;
establishing communication between the money exchange server and a second user computing device, the second user computing device providing access to a second payment account that is registered with the money exchange server, wherein the second payment account is associated with a second user;
transmitting the request for cash amount from the money exchange server to the second user computing device;
accepting the request for cash amount via the second user computing device;
transmitting an acceptance message from the second user computing device to the money exchange server; and,
transmitting from the money exchange server the location information of the first user computing device to the second user computing device.

2. The computer-implemented method of claim 1, wherein the first payment account has funds available, further comprising the steps of:
confirming the transfer of cash amount using the first user computing device and transmitting a confirmation message from the first user computing device to the money exchange server;
confirming the transfer of cash amount using the second user computing device and transmitting a confirmation message from the second user computing device to the money exchange server; and
transferring the funds from the first payment account to the second payment account, wherein the funds transferred from the first payment account to the second payment account is an amount that is more than or equal to the cash amount requested.

3. The computer-implemented method of claim 2, further comprising the step of:
confirming that the first payment account has funds available that are more than or equal to the cash amount requested.

4. The computer-implemented method of claim 1, further comprising the step of:
transmitting a confirmation message to the first user computing device that the request for cash amount has been accepted.

5. The computer-implemented method of claim 1, wherein the location information includes geographical coordinates, directions, or a map.

6. The computer-implemented method of claim 1, wherein a payment app downloaded on the first user computing device is used to request the cash amount.

7. The computer-implemented method of claim 1, wherein the step of establishing communication between the first user computing device and the money exchange server, includes the steps of:
sending a ready to transact message from the first user computing device to the money exchange server; and
sending a verification message from the money exchange server to the first user computing device.

8. The computer-implemented method of claim 1, further comprising the step of:
determining whether the first user computing device meets a first parameter.

9. The computer-implemented method of claim 8, wherein the first parameter is one of distance, time, and location.

10. The computer-implemented method of claim 1, further comprising the step of:
storing the location information of the first user computing device in a memory of the money exchange server.

11. A computer-implemented method of exchanging a cash amount for electronic payment, the method comprising the steps of:
registering a first payment account with a money exchange server using a first computing device, wherein the first payment account is associated with a first user;
establishing communication between the first user computing device and the money exchange server;
transmitting a request for cash amount from the first user computing device to the money exchange server, wherein the request for cash amount includes location information of the first user computing device;
storing the location information of the first user computing device on the money exchange server;
establishing communication between the money exchange server and a second user computing device, the second user computing device providing access to a second payment account that is registered with the money exchange server, wherein the second payment account is associated with a second user;
establishing communication between the money exchange server and a third user computing device, the third user computing device providing access to a third payment account that is registered with the money exchange server, wherein the third payment account is associated with a third user;
transmitting the request for cash amount from the money exchange server to the second user computing device and the third user computing device;
accepting the request for cash amount via the second user computing device;
transmitting an acceptance message from the second user computing device to the money exchange server; and
transmitting from the money exchange server the location information of the first user computing device to the second user computing device.

12. The computer-implemented method of exchanging cash for electronic payment of claim 11, further comprising the steps of:
declining the request for cash amount via the third user computing device; and
transmitting a decline message from the third user computing device to the money exchange server.

13. The computer-implemented method of exchanging cash for electronic payment of claim 11, further comprising the steps of:
sending the location information of the second user computing device to the money exchange server;
accepting the request for cash amount via the third user computing device;
sending an acceptance message from the third user computing device to the money exchange server;
sending the location information of the third user computing device to the money exchange server; and
determining the distance between the first user computing device and the second user computing device and the first user computing device and the third user computing device based on the location information of the first, second, and third user computing devices, wherein the distance between the first user computing device and the second user computing device is less than the distance between the first user computing device and the third user computing device.

14. The computer-implemented method of claim 13, further comprising the step of:
storing the location information of the first, second, and third user computing devices in a memory of the money exchange server.

15. The computer-implemented method of claim 13, wherein the second and third user computing devices are located within a radius of the first user computing device.

16. A system for exchanging a cash amount for electronic payment using a payment app, the system comprises:
a money exchange server;
a first user computing device configured to communicate with the money exchange server, which transmits a request for cash amount to the money exchange server via the payment app;
a second user computing device configured to communicate with the money exchange server, which receives the request for cash amount from and sends an acceptance of the request for cash amount to the money exchange server via the payment app;
a first electronic payment account associated with the first user computing device; and
a second electronic payment account associated with the second user computing device;
wherein the money exchange server facilitates the transfer of electronic funds from the first payment account to the second payment account in an amount that is more than or equal to the cash amount requested.

17. The system for exchanging cash for electronic payment of claim 16, wherein the money exchange server facilitates the transfer of electronic funds after it receives a message from the first user computing device confirming the transfer of the cash amount requested.

18. The system for exchanging cash for electronic payment of claim 16, wherein the first payment account and the second payment account are registered with the money exchange server.

19. The system for exchanging cash for electronic payment of claim 16, wherein communication between the first user computing device and the money exchange server occurs over a first communication channel.

20. The system for exchanging cash for electronic payment of claim 16, wherein communication between the second user computing device and the money exchange server occurs over a second communication channel.
